(19) United States
(12) Patent Application Publication
(10) Pub. No.: US 2016/0284020 A1
(43) Pub. Date: Sep. 29, 2016

(54) System And Method for a Peer to Peer Exchange of Consumer Information

(71) Applicant: Credigy Technologies Inc., Las Vegas, NV (US)

(72) Inventor: Jason S. Williams, Braselton, GA (US)

(21) Appl. No.: 15/085,267

(22) Filed: Mar. 30, 2016

Related U.S. Application Data
(63) Continuation of application No. 11/145,153, filed on Jun. 3, 2005, now abandoned.

(51) Int. Cl. G06Q 40/00; H04L 29/06; G06Q 20/40

(52) U.S. Cl. CPC G06Q 40/00; G06Q 20/401; H04L 65/1069

(57) ABSTRACT

Using peer-to-peer networking to exchange consumer information in a secure environment. The seeker of consumer information transmits an encrypted query to authenticated and trusted peers which includes legal representations stating the legally permissible purpose for seeking the information. A peer, acting as a maintainer of consumer information, determines if the query matches any consumer information held by the maintainer. The maintainer then informs the seeker of the results of the match, the type of information available, the data format, and the price for such consumer information. A payment invoice can be generated and electronically presented by maintainer. The payment may be electronically debited from the designated account of seeker and remitted to maintainer. In addition, a portion of such funds may be delivered to an entity which maintains the peer-to-peer software.

### RELATED APPLICATIONS

This patent application is a continuation of U.S. patent application Ser. No. 11/145,153, filed Jun. 3, 2005. The complete disclosure of the above-identified application is hereby fully incorporated by reference.

### FIELD OF THE INVENTION

The invention relates generally to a data exchanging arrangement in a computer network, and more particularly to an exchange of consumer information in a peer-to-peer commerce network.

### BACKGROUND OF THE INVENTION

Many companies require consumer and commercial data to conduct business. In particular, the utilization of consumer information has expanded dramatically over the past several years. Consumer Information is data which can be directly related to a particular individual, and is the key set of information on which a substantial, and growing, percentage of both traditional and electronic commerce is based. Any commerce which is not anonymous generally relies on Consumer Information to some degree. As the value associated with a particular instance of commerce increases, the desire for Consumer Information generally increases.

The type of consumer information exchanged between commercial entities is diverse, including, but not limited to, identification information, demographic information, financial information, and health information. Financial information can include financial account information, such as the status of a financial account held by an individual or entity. Consumer information is critical in a variety of commercial applications. Our information-based society, where the primary medium of transacting business is now electronic, is dependent on consumer information. For example, if a collection agency is seeking data on a debtor to collect a debt, it may first check some large data brokers for consumer information related to the debtor, such as current address, phone or employment information to “skip trace” the debtor. It is probable that the data retrieved will be outdated or incorrect. Thereafter, the collection agency may try other methods of locating debtors, including contacting neighbors, associates and other creditors of the debtor and other techniques known in the art of skip tracing such as reviewing available public records. The current methods of skip tracing do not efficiently utilize the vast amount of consumer information held by other collection agencies, financial institutions, small businesses and the like.

The increasing demand for consumer information has precipitated a variety of privacy concerns which has in turn restricted the exchange of such information in many countries and political subdivisions of those countries. As the demand for consumer information continues to grow exponentially, there is a need for improved methods of consumer information exchange to accommodate privacy concerns and the complex array of laws regulating the exchange of such information while facilitating an increased flow of information from previously unavailable sources.

Accordingly, there is a need for a consumer information data exchange where entities, such as small businesses and collection agencies, may exchange consumer information in an efficient manner while complying with applicable laws. Such a network may provide access to previously unavailable sources of consumer information, create new revenue for maintainers of consumer information, reduce the transaction costs associated with the exchange of such information, and provide a framework for compliance with applicable laws.

One efficient model for the exchange of data is a peer-to-peer network model, where each peer interacts directly with the other peers over a communications network, with little or no centralized authority. In the last several years a variety of, principally non-commercial, methods for the exchange of data using peer-to-peer technologies have been developed. Widely distributed software applications such as Gnutella™ and BitTorrent® utilize the methods developed for the peer-to-peer exchange of data. The methods utilized by such peer-to-peer software applications are diverse. Peer to peer applications such as the early versions of Napster® utilize a server to index and classify content available on the peer-to-peer network, while other applications such as Gnutella, depend entirely on available peers for identification and classification of content. BitTorrent has taken the peer-to-peer model even farther towards decentralization by taking singular chunks of data, such as a digital movie file, splitting the chunk of data into many small parts, and distributing the parts throughout a peer to peer network.

Use of peer-to-peer networks of data exchange is expanding rapidly on a global basis, as peer-to-peer networks offer many advantages over traditional client-server methods. In particular, peer-to-peer methods of data exchange offer increased redundancy, increased bandwidth, distribution of content over a wide area, and lower costs among others benefits. While the advantages of peer-to-peer networks of data exchange have been capitalized upon in the exchange of digital music and video files, peer-to-peer networks of data exchange are utilized on a limited basis in financial applications, and not at all to exchange consumer information.

Accordingly, there is a need for a Peer-to-Peer network of data exchange to facilitate the transfer of consumer information while accommodating privacy concerns embodied within applicable laws and regulations. In particular, there is a need for a software application which can function over a widely distributed Communications Network and connect a large number of peers to facilitate the secure commercial exchange of consumer information in compliance with a variety of laws and regulations.

### SUMMARY OF THE INVENTION

The present invention satisfies the need for a data exchange to facilitate the exchange of Consumer Information by providing a Peer-to-Peer commerce exchange allowing Peers to exchange data, such as Consumer Information, in an efficient and economic manner in compliance with applicable laws. Advantageously, such a Peer-to-Peer Exchange would allow even small entities to access and supplement the universe of consumer information, which may decrease or eliminate the need for centralized, industry-wide proprietary databases, such as those maintained by Consumer Reporting Agencies and large, unregulated data brokers, while expanding the set of available Consumer Information. For example, the present invention may allow a small collection agency to access up-to-date information on a particular debtor that would otherwise be unavailable. The collection agency may request a current phone number on a “John Doe” and include a legal representation as to the permissible purpose of the collection agency in accessing such data. A utility company, which typically does not report accounts to a consumer reporting agency, may respond permissibly with the current phone number of the debtor. The collection agency receives the current data and, in turn, the utility company can generate revenue from its consumer data while complying with applicable law.

Peers utilizing the present invention may be seeking Consumer Information for a variety of reasons. In addition to the skip-tracing function where a Peer may be seeking a current address or phone number, a creditor may use the inventive Peer-to-Peer system to seek other information, including but not limited to current financial account transactions or recent payment histories of a consumer who is not listed in the large Consumer Reporting Agency databases to establish credit. Additionally, the inventive Peer-to-Peer System may be utilized for other purposes such as to verify the identity of a consumer, to obtain consumer addresses for market-specific advertising or to find data to complete a discovery requirement of a law suit.

Because Consumer Information is a key component of modern commerce, such information is valuable. As with anything of value, Consumer Information may be difficult to protect from misappropriation. Once Consumer Information is misappropriated, fraudulent instances of commerce resulting from identity theft may result. The competing preferences of protecting consumer privacy and making Consumer Information readily obtainable to facilitate commerce must be carefully balanced in order to preserve the fluidity of commerce while avoiding fraudulent instances of commerce. The balancing of these competing preferences is most often embodied in governmental regulatory schemes. The increasing importance of Consumer Information as a component of commerce has increasingly made such regulatory schemes complex and difficult to comply with, as widely differing requirements may exist depending on the type of information exchanged and the laws applicable to the entities exchanging information. The difficulty of complying with such regulatory schemes often increases the cost of commerce. The present invention may dramatically lower the cost of complying with such regulatory schemes by providing a Peer-to-Peer method and system that maintains consumer privacy while also allowing businesses to exchange Consumer Information for permissible purposes.

One aspect of the present invention provides a Peer-to-Peer Exchange of Consumer Information where the functionality of the Peer-to-Peer Exchange is entirely decentralized. An instance of a Peer-to-Peer Software Application is operated by each Peer connected to a Communications Network, to provide Consumer Information and related services to other Peers over the Communications Network.

To enable efficient communication between Peers, a Standard Data Format may be utilized for querying and responding to the queries of other Peers. For example, the Peers utilize XML as the Standard Data Format for queries and responses to queries, using a globally defined XML DTD for querying and matching. While a globally defined XML DTD is used for the query process, each Peer may use one or more Peer defined XML DTDs to transmit data in a Transaction from its Consumer Information Database. As a result, flexible content delivery is supported without the involvement of a centralized authority, such as a data broker. However, in alternative aspects of the invention, other data or computing standards may be utilized by the Peers for the exchange of queries, responses to queries and data exchange, such as delimited text files, fixed length files and the like.

For one inventive aspect, a Software Distributor initially provides the requisite Peer-to-Peer Software Application to at least one Peer for downloading to a General Purpose Computing Device connected to a Communications Network. The Peer may then share the Application with other potential Peers, direct them to the Software Distributor, or otherwise make the Peer-to-Peer Software Application available. As discussed below, the Software Distributor, in other aspects of the invention, may also act as a centralized source for some functions of the Peer-to-Peer Exchange.

The Peer-to-Peer Software Application can perform multiple steps to establish communications with the other discovered Peers on the Communications Network, including Authenticating each Peer designated for a Communications Session and determining the level of Trust associated with each Peer. If a Peer is not Authenticated or the Trust Metric Rating for that Peer is below an acceptable value, the Communications Session with that Peer is canceled.

The Peer-to-Peer Software Application can comprise numerous software-implemented components or modules. For a representative implementation of the Peer-to-Peer Software Application, an Indexing Component indexes the Peer's Consumer Information Database. To create an Index, a set of universal attributes is initially extracted from the underlying Database for each consumer in the Database, and updated periodically thereafter based on a differential analysis. The set of universal attributes includes a sufficient quantum of information to enable any participant in the Peer-to-Peer network to determine what other Peers have a record or records matching a request. The set of universal attributes may include names, social security numbers, dates of birth, addresses, phone numbers and other such data attributes useful for personally identifying individuals and Record Types.

When a Peer is seeking data, the query function of a Look Up Component receives a manual or batch input of requested data and passes the set of data to a Transformation Component for conversion to a pre-determined Standard Data Format. For one aspect of the invention, the Standard Data Format is defined by an XML DTD common to all instances of the Peer-to-Peer Application. The Look Up Component of the Peer-to-Peer Software Application then sends the query out to known Peers, who in turn forward the query to additional known Peers. However, in alternative aspects of the invention, the Look Up Component may provide a method for distributing and forwarding the queries to the most efficient number of other Peers, who in turn may distribute the queries to the most efficient number of additional Peers. In general, a query is rapidly propagated through the decentralized Peer network.

When submitting a query, each Peer is responsible for one or more Legal Representations concerning its use of Consumer Information, its security measures and the accuracy of its own Consumer Information. The Legal Representations ensure that the Peer has made a contractual representation of a legally allowable purpose for obtaining Consumer Information. Each time a Peer transmits a query to another Peer, that query typically includes such a Legal Representation, identifying the particular permissible legal purpose upon which the request is based.

When receiving a query from another Peer, the Look Up Component receives the query, via a Connection Component, from Authenticated and Trusted Peers. The Look Up Component processes the incoming queries against the Index. When a match is obtained against the Index, a Messaging Component returns the count of matches, the Record Type of each match, the date of each match, the XML DTD for the Record Type of each match, and the cost per record for each record type to the requesting Peer. To the extent specified by the requesting Peer, the query function may then extract the matching data from the underlying Database and pass the data to the Transformation Component for conversion to the defined XML DTD for the record type and transmission to the requesting Peer via a File Transfer Component. The Transformation Component operates on both an inbound and outbound basis.

The File Transfer Component provides the function of transmitting and receiving files comprised of data records in the defined XML DTD format. The File Transfer Component may queue requests that have been produced for transmission and may be initiated in either a push or pull mode. To preserve the integrity of data transmission, the File Transfer Component requires an acknowledgment of a completed and successful transmission prior to initiating a subsequent transmission to the same Peer.

The revenue model in this aspect of the invention is two-fold: requesting Peers pay providing Peers for successful Transactions and a percentage of the payment is transmitted to the Software Distributor, as a royalty or licensing fee. A Settlement Component provides the accounting function for successful Transactions based on the Record Type transmitted and the price associated with that Record Type. The Settlement Component can transmit electronic invoices to the requesting Peer. In addition, the Settlement Component generates a notification to the Software Distributor in order to facilitate the collection of royalty payments. In alternative aspects of the invention, any suitable party may collect the Transaction and royalty payments for each successful Transaction. For example, Settlement data may be transmitted to an external billing system. Additionally, a Peer may accept any form of payment, including but not limited to digital money tokens, payment provided through third party payment systems, such as the VISA®/MasterCard® networks, and the like. For other inventive aspects, payments may be exchanged between Peers, transferred to a central authority, or utilize other feasible payment or bartering models.

Additionally, an Update Component enables a party operating a particular instance of the invention to distribute modifications to each instance of the Application operating on the Communications Network. The Update Component permits the party maintaining the code base of the Peer-to-Peer Software Application operated, relative to a particular instance, to digitally sign updates and preserve the integrity of the code base. The resultant versioning may be utilized as a Trust Metric by the Security Component.

In addition to the inventive aspects described above, the Peer-to-Peer System may be arranged in a variety of other configurations, including but not limited to: centralized indexing and querying with distributed content, centralized security and distributed Indexing and the like.

For another aspect of the invention utilizing a method of centralized security and Indexing with distributed content, a system is deployed whereby at least one instance of the operating Peer-to-Peer Software Application is designated as the server. The server instance may serve as, or facilitate access to, a centralized Trust authority for purposes of Trust and Authentication. Additionally, each Peer may transmit their Index to a centralized server application. As a result, queries against the content Indices are processed by this centralized server application. For example, the non-server instances of the Application may transmit Indices compiled by the Indexing Component to the server instance of the Application. All data requests are then transmitted by the non-server instances of the Application to the centralized Index maintained by the server instance of the Application for matching. When a match occurs, the server instance of the Look Up Component responds with additional information, such as the route to a Peer on the shared Communications Network offering the requested information.

The foregoing has broadly outlined some of the aspects and features of the present invention, which should be construed to be merely illustrative of various potential applications of the invention. Other beneficial results can be obtained by applying the disclosed information in a different manner or by modifying the disclosed inventive aspects. Accordingly, other aspects and a more comprehensive understanding of the invention may be obtained by referring to the detailed description of the exemplary embodiments taken in conjunction with the accompanying drawings, in addition to the scope of the invention defined by the claims.

### BRIEF DESCRIPTION OF THE DRAWINGS

The accompanying drawings, which are incorporated in and constitute a part of this specification, illustrate embodiments of the invention, and together with the description, serve to explain the principles of the invention.

FIG. 1 is a block diagram depicting the functional components of an exemplary embodiment of the present invention.

FIG. 2 depicts a context diagram for a Peer-to-Peer system constructed in accordance with an exemplary embodiment of the present invention.

FIG. 2A depicts a workflow diagram for an “Authentication, Encryption and Trust” process of an exemplary embodiment of the present invention.

FIG. 3 is a workflow diagram for a “Seeking Data” process of an exemplary embodiment of the present invention.

FIG. 3A is a workflow diagram for a process for providing a legal representation in accordance with an exemplary embodiment of the present invention.

FIG. 4 is a workflow diagram for a “Providing Data” process of an exemplary embodiment of the present invention.

FIG. 4A is a workflow diagram for a “Skip Tracing” process of an exemplary embodiment of the present invention.

FIG. 4B is a workflow diagram for a “Credit Reporting” process of an exemplary embodiment of the present invention.

FIG. 5 depicts the Components of a Peer-to-Peer Software Application constructed in accordance with an exemplary embodiment of the present invention.

FIG. 6 depicts the functions of the Components of a Peer-to-Peer Software Application constructed in accordance with an exemplary embodiment of the present invention.

### DETAILED DESCRIPTION OF THE EXEMPLARY EMBODIMENTS

As required, detailed embodiments of the present invention are disclosed herein. It will be understood that the disclosed embodiments are merely examples to illustrate aspects of the invention that may be embodied in various and alternative forms. The figures are not necessarily to scale or in a sequential order, and some features may be exaggerated or minimized to show details of particular Components. In other instances, well-known materials or methods have not been described in detail to avoid obscuring the present invention. Therefore, specific structural and functional details disclosed herein are not to be interpreted as limiting, but as a basis for the claims and for teaching one skilled in the art to variously employ the present invention.

As used in the description herein and attachments hereto, the meaning of “a,” “an,” and “the” includes plural reference unless the context clearly dictates otherwise. Also, as used in the description herein and attachments hereto, the meaning of “in” includes “in” and “on” unless the context clearly dictates otherwise. Finally, as used in the description herein and attachments hereto, the meanings of “and” and “or” include both the conjunctive and disjunctive and may be used interchangeably unless the context clearly dictates otherwise. Defined terms carry the stated definitions whether expressed as nouns, verbs, adjectives or any other grammatical variation, throughout the specification and claims.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Further, although process steps, method steps, systems or the like may be described in a sequential order, such processes, methods and systems may be configured to work in alternate orders. In other words, any sequence or order of steps that may be described does not necessarily indicate a requirement that the steps be performed in that order. The steps of processes described herein may be performed individually or in any order practical. Further, some steps may be performed simultaneously.

It will be readily apparent that the various methods and systems described herein may be implemented by, e.g., appropriately programmed General Purpose Computing Devices. Typically a processor (e.g., a microprocessor) will receive instructions from a memory or like device, and execute those instructions, thereby performing a process defined by those instructions. Further, sets of instructions that implement such methods and algorithms may be stored as programs and transmitted using a variety of known media.

The data exchange of certain embodiments of the present invention can be implemented in hardware, software or a combination thereof. In one exemplary embodiment, the data exchange is implemented in software or firmware that is stored in a memory or computer readable medium, and that is executed by a suitable instruction execution system. If implemented in hardware, as in an alternative embodiment, the data exchange can be implemented with any technology, which is known in the art.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor, and the like. Transmission media may include or convey acoustic waves, light waves and electromagnetic emissions, such as those generated during radio frequency (RF) and infrared (IR) data communications, or any other wireless form of communication. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Where databases are described, it will be understood by one of ordinary skill in the art that (i) alternative database structures to those described may be readily employed; (ii) other memory structures besides databases may be readily employed.

Devices that are in communication with each other need not be in continuous communication with each other, unless expressly specified otherwise. In addition, devices that are in communication with each other may communicate directly or indirectly through one or more intermediaries. Additionally, a description of an embodiment with several Components in communication with each other does not imply that all such Components are required. On the contrary a variety of optional Components are described to illustrate the wide variety of possible embodiments of the present invention.

### Data Definitions

Communications Network Protocol—The specification of a set of rules for communication.

Consumer Information—Identification information, demographic information, financial information, including financial account information, and other information related to identifiable individuals or to entities, such as businesses.

Consumer Information Database—A collection of Consumer Information.

Index—A set of keys, each of which, or a combination of which, identifies a record, or set of records, located on a particular database in a particular structure on the database and referenced on the structure of the database by the particular key of the Index.

Legal Representations—A statement of a fact as of a certain time which may or may not have constraints on its duration and applicability, made by one party to another as a term of a particular Transaction, such that the party receiving the Legal Representation can contractually rely on it to take some action.

Record Type—A classification of a set of data elements, such as the classifications employment data, address data, and telephone data.

Standard Data Format—A set of rules which defines the type, format and other meta-characteristics of sets of data.

Trust Metric—A measurement of how confident a Peer is in the identity, reliability and security of another Peer relative to a particular material issue, e.g. data quality.

Trust Metric Rating—The value calculated for a Trust Metric.

Extensible Markup Language (XML)—A Standard Data Format which constitutes a meta-language, or language used in describing other languages, that allows the creation of customized data tags, enabling the definition, transmission, validation and interpretation of data between applications and between users.

XML Document Type Definition (DTD)—Defines the tags and attributes used in an XML data set, which of those tags can appear within other tags and describes the content of that data set, enabling another program to interpret the described data set.

### System Definitions

Authentication—A process of confirming identity.

Communications Network—A set of nodes which can transmit or receive messages over a communications medium using a Communications Network Protocol.

Communications Session—A connection over a Communications Network between mutually Authenticated Peers.

Component—Individual computing processes designed to perform a particular function or set of functions by receiving inputs of data and producing outputs of data, a group of which may collectively form a Peer-to-Peer Software Application.

General Purpose Computing Device—A device comprising a processor, such as a microprocessor, that receives instructions from a memory device and executes those instructions, thereby performing a process defined by those instructions and producing an output of data.

Peer-to-Peer Software Application—A set of Components which permits the user of the Application to participate in a Peer-to-Peer System.

### Component Definitions

Connection Component—A computing process that manages connections with Communications Networks, users of Communications Networks and instances of the Peer-to-Peer Software Application operating on a Communications Network.

File Transfer Component—A computing process that transmits and receives sets of data records stored in a memory device as a file.

Encryption Component—A computing process that provides security and privacy to transmissions by transforming transmissions to and from a plain text or a cipher text according to a specific algorithm and a secret code or set of secret codes.

Indexing Component—A computing process that creates an Index of a database.

Kernel Component—A computing process that manages and connects other Components.

Logging Component—A computing process that records the activity of other Components.

Look Up Component—A computing process that generates, transmits, processes and forwards queries in the defined Data Format to other instances of the Peer-to-Peer Software Application operating in a Communications Network.

Mapping Component—A computing process to produce DTDs defined by a particular Peer, such as mapping the fields in a Consumer Information Database to a DTD as defined by that Peer.

Messaging Component—A computing process that creates and distributes messages.

Reporting Component—A computing process that creates an organized presentation of Transactions, Settlements or other activity recorded by the Logging Component in a human readable format.

Scheduler Component—A computing process that triggers other Components to perform a function on either a periodic or event triggered basis.

Security Component—A computing process that provides a method for authorizing the transmission of data in a particular Communications Session, according to selected Trust Metrics and Trust Metric Ratings.

Settlement Component—A computing process that manages the accounting for successful Transactions based on the Record Type transmitted and the price associated with that Record Type.

Transformation Component—A computing process that converts raw data to a Standard Data Format defined by the Peer or the Peer-to-Peer Software Application.

Updating Component—A computing process that provides a method whereby the party operating a particular instance of the invention can distribute modifications of the Peer-to-Peer Software Application to other instances of the Application operating on the shared Communications Network.

Peer-to-Peer System—A type of network architecture in which each user entity has equivalent capabilities and responsibilities, as opposed to a “client/server” architecture in which one entity is dedicated to serving the others.

Public Key Infrastructure—A technique to protect data using an algorithm (e.g. the RSA Algorithm) and two keys, a public key that one disseminates to anyone for encrypting data and a private key that one uses to decrypt received data encrypted with the matching public key or digitally sign data.

Quality of Service—A process to allocate resources in order to maintain a level of throughput or bandwidth according to a specified prioritization method.

Settlement—The process of the requesting party of a Transaction delivering the requisite payment to the responding party of a Transaction.

Transaction—The process of one party requesting a particular set of data and another party delivering the particular set of data to the requesting party.

### System Users Definitions

Peer—A system user, a particular instance of the Peer-to-Peer Software Application or a node of a Peer-to-Peer System.

Software Distributor—Entity that initiates a Peer-to-Peer System with the initial distribution of a Peer-to-Peer Software Application.

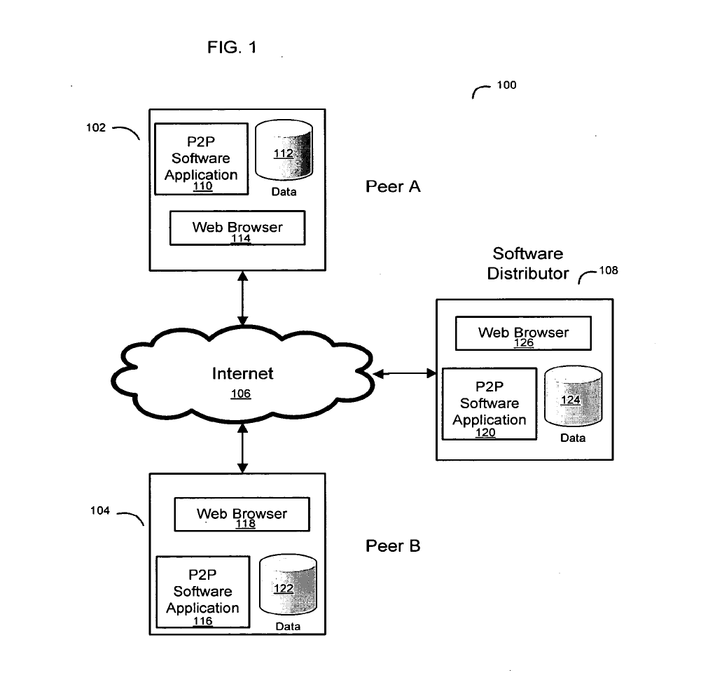

Referring now to the drawing set, FIG. 1 is a block diagram depicting a Peer-to-Peer System 100 constructed in accordance with an exemplary embodiment of the present invention. The Peer-to-Peer System 100 as shown includes a Peer A 102, a Peer B 104 and a Software Distributor 108 connected via the Internet 106. In this exemplary embodiment, the Internet 106 is the Communications Network. In alternative embodiments, the Peer-to-Peer network of the present invention could utilize an alternative Communications Network, such as a private ATM network.

Peer A 102 is connected to the Internet 106 via an operating system (OS) operating on the Peer's general purpose computing device, running a web browser application 114 and an instance of the Peer-to-Peer Software Application 110 of the present invention. The web browser application 114, or any standard browser application, is the user interface to the Peer-to-Peer Software Application 110. In addition, Peer A 102 maintains a database 112 of Consumer Information, which may be operating on a distinct general purpose computing device connected over a Communications Network, such as a local area network, to the general purpose computing device on which the Peer-to-Peer Software Application is operating. In alternative embodiments, the database may contain any other types of data in addition to or in replace of Consumer Information, including financial data, commercial data and the like.

Peer A 102 may interact with the Peer-to-Peer Software Application 110 through the web browser 114. For example, Peer A 102 may enter data and choose query types on a displayed browser page. In alternative embodiment of the Peer-to-Peer network of the present invention, there may be a different user interface mechanism, or the Peer systems may communicate and transact automatically, based on pre-selected criteria or based on user inputs collected at a centralized web portal.

Peer B 104 is also connected to the Internet 106 via an OS running a web browser application 118. Peer B 104 is similarly running an instance of the Peer-to-Peer Software Application 116 and maintains a database 122 of Consumer Information, which also may be operating on a separated, connected general purpose computing device. For example, Peer B may be a collection agency with a database of debt accounts, or a mortgage broker which processes mortgage loan applications. The databases of the Peers may operate on any platform and may utilize any database language such as SQL, known now or in the future.

A Software Distributor entity 108 is also depicted in FIG. 1 as connecting to the Internet 106. The Software Distributor 108 provides the Peer-to-Peer Software Application 120 for downloading over the Internet 106. In this exemplary embodiment, the Software Distributor 108 provides two primary functions: to maintain and distribute the latest version of the Peer-to-Peer Software Application 120; and to collect royalty payments. For example, if Peer B 104 provides consumer information to Peer A 102 for a small fee, a fraction of that fee may be automatically transmitted to the Software Distributor 108 as a licensing or royalty fee for the use of the Peer-to-Peer Software Application 120.

In alternative embodiments, the Software Distributor 108 may be differently configured or may be eliminated. For example, the Software Distributor 108 may provide a central Index of data available from all Peers in addition to serving as the distribution point for software updates.

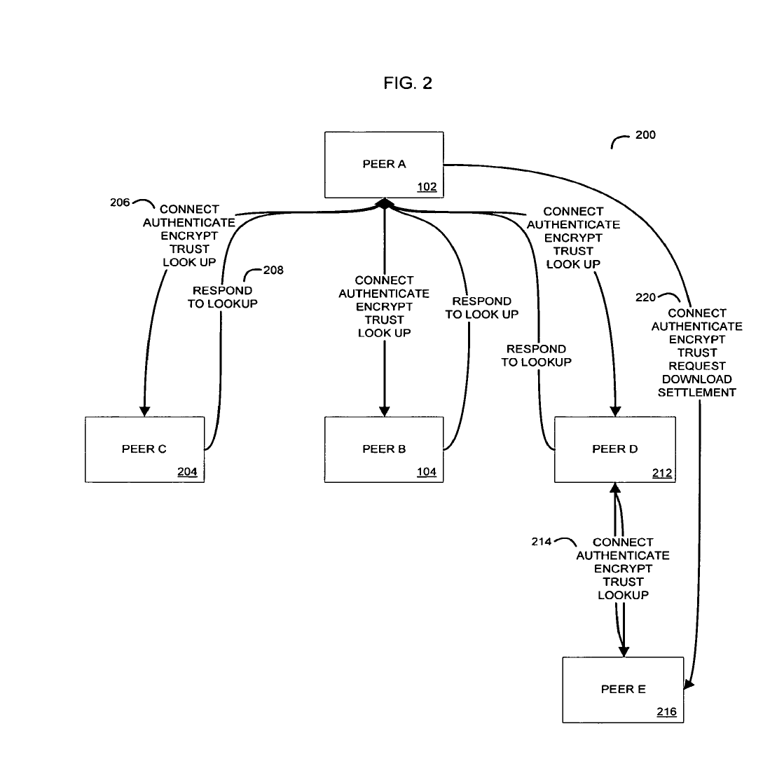

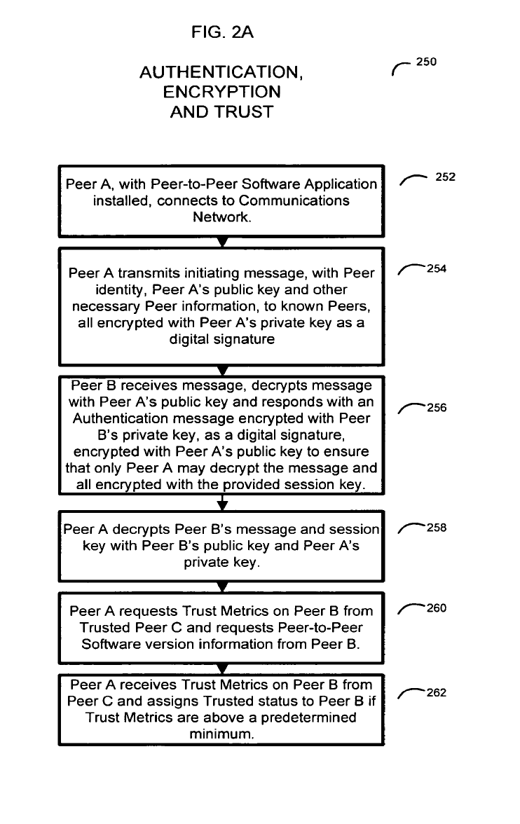

FIG. 2 depicts a context diagram 200 of Peer A 102 seeking data in a Peer-to-Peer network, in accordance with an exemplary embodiment of the present invention. For example, Peer A 102 may be a collections agency seeking a current phone number for a particular debtor. The phone number information for the debtor may be incorrect in Peer A's Database 112 and in the databases of the major Consumer Reporting Agencies and data brokers. Peer A 102 may use the Peer-to-Peer network to query other Peers and obtain a current phone number for the debtor.

As shown, Peer A 102 will first communicate with known Peers, being Peer C 204, Peer B 104, and Peer D 212. Peer A 102 is running an instance of the Peer-to-Peer Software Application of the present invention which performs the processes 206 of connecting with the known Peer C 204 over a Communications Network, Authenticating with Peer C 204, encrypting transmissions to Peer C 204, verifying a minimum Trust Metric Rating with Peer C 204, and transmitting a query via a Look Up Component to Peer C 204. These communications are being conducted by both Peers, as they Authenticate each other. In this example, the query states the known parameters, such as debtor name and social security number, and requests certain other parameters such as verified address and phone number. Peer C 204 may transmit a response 208 to Peer A 102. The response 208 is generated by the Look Up Component of Peer C 204 and encrypted for transmission by an Encryption Component of the instance of the Peer-to-Peer Software Application of Peer C 204. The Peer-to-Peer network of this exemplary embodiment utilizes the PGP Web of Trust method for authenticating other Peers and encrypting transmissions.

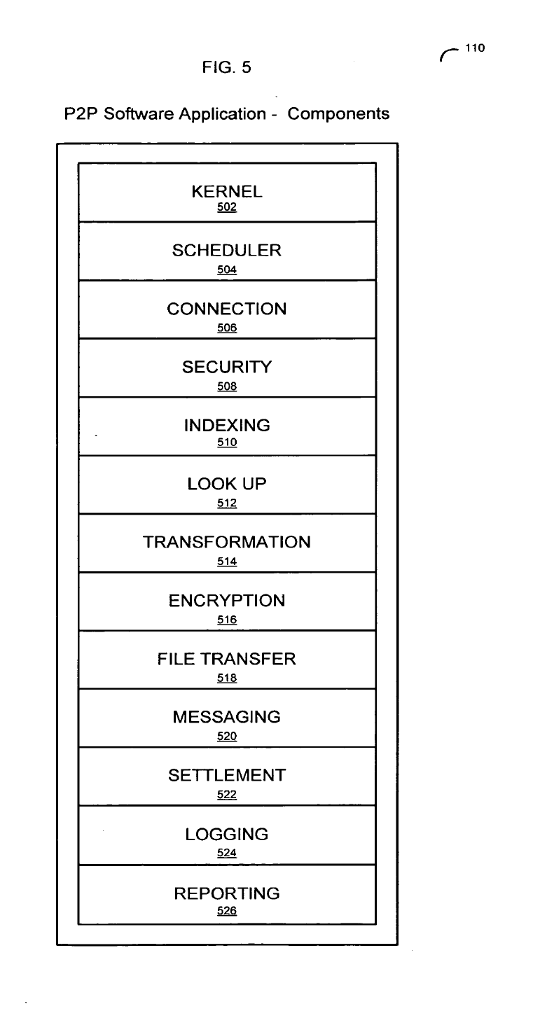

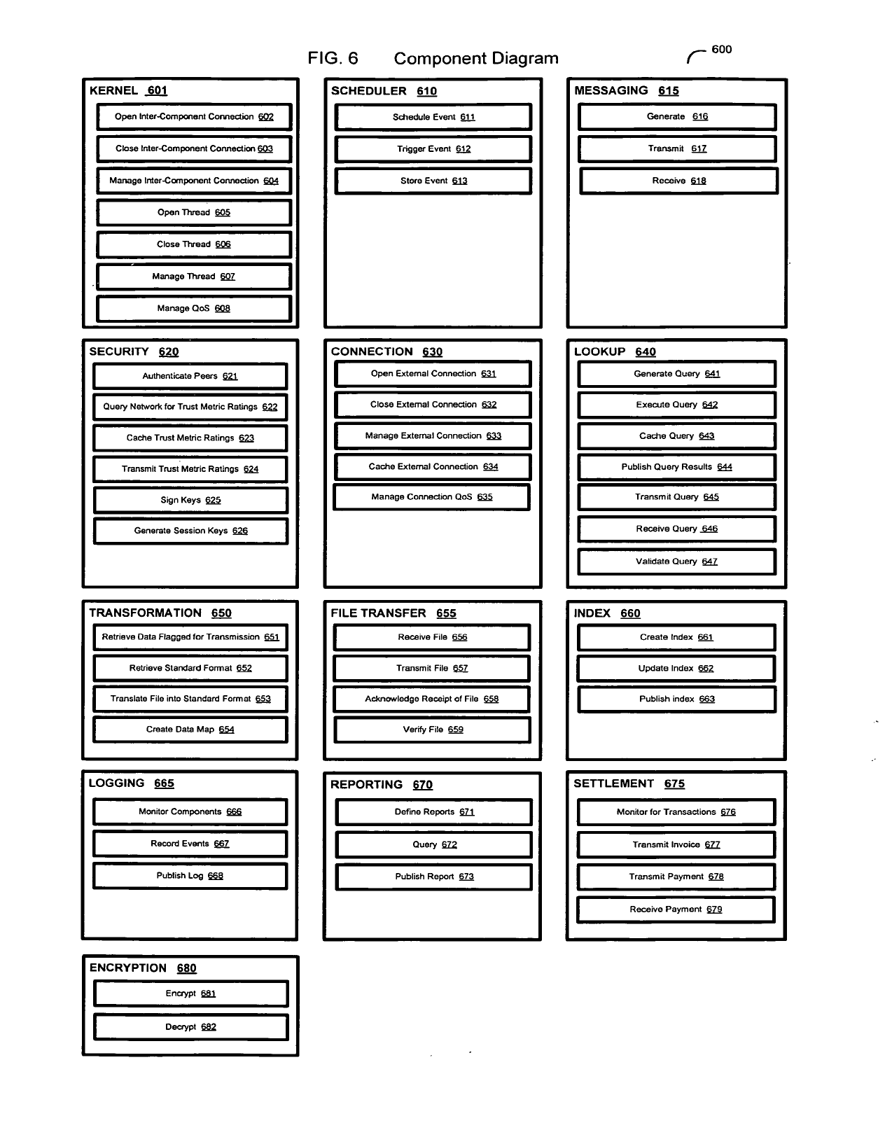

To Authenticate a particular Peer, as will be discussed more thoroughly with respect to FIGS. 5 and 6, a Security Component receives the Peer's stated identity and verifies that identity. In this exemplary embodiment, each Peer uses the PGP Web of Trust model to Authenticate other Peers. In alternative embodiments, a Peer may utilize an alternate Public Key Infrastructure provided by a company such as Verisign®, or another method to verify the identity of a Peer. Once Authenticated with another Peer, a Peer may transmit and receive queries during the Communications Session, such as queries seeking certain Consumer Information.

FIG. 2 further depicts how Peer A 102 will transmit the exact same communications, verifications and query to the other known Peers on the Communications Network, Peer B 104 and Peer D 212. In this exemplary embodiment a Peer, such a Peer D 212, may forward the query 214 to Peers, such as Peer E 216, that are known to Peer D 212 but not known to Peer A 102. If Peer E 216 contains data matching the query, the Peer-to-Peer Software Application instance of Peer E 216 will automatically transmit the response stating a match back to Peer D 212, who will automatically forward a “Match Found” response to Peer A 102. In alternative embodiments, Peer E may authenticate and establish trust directly with Peer A without using Peer D as an intermediary. Peer A 102 may then initiate communications through the Authentication and Trust processes 220 directly with Peer E 216 and request the matching data record(s). Peer E 216 may then transmit the current account data to Peer A 102.

The Peer-to-Peer Software Application of the present invention may use many different models for the transmitting and forwarding of queries. For example, in the simplest form, a Peer sends a query to every known other Peer. In alternative embodiments, the Peer may send a query to only the 50 most recently authenticated Peers, the 50 Peers with the highest current bandwidth, the 50 Peers reachable in the minimum number of hops, other such parameters or a combination thereof. Additionally, in alternative embodiments, a Peer may not forward a query to other Peers unknown to the originating Peer unless a notification is received stating that no match was yet found in the first iteration of a query. In that case, a Peer may then forward the query to Peers that were not known to the originating Peer, such as Peer E 216 in FIG. 2.

Those skilled in the art will recognize that FIG. 2 does not illustrate the entire Settlement function. In addition to the disclosure of FIG. 2, Peer E 216 may transmit an invoice to Peer A 102 seeking compensation for the provided data. Peer A 102 may then transmit the payment to Peer E 216 and transmit a royalty fee to a Software Distributor entity. In alternative embodiments, the Settlement Component may utilize a type of Peer escrow. For example, to ensure that the invoice is paid, Peer A 102 may send the payment to Peer D 212 and Peer E 216 may send the data to Peer D 212. Peer D 212 will only release the payment and data after both have been received.

In this exemplary embodiment, the Peer providing data establishes its fee for transmitting the matching record(s) to the requesting Peer. A Peer may charge a higher rate for data that is more recently updated, authenticated in some manner, and for particular types of records. For example, different fees might charged for a record type that just provides a phone number as opposed to a record type that provides a history of recent payments on an open account. In alternative embodiments, a fee schedule or set of maximum fees may be established by the Peers or may be included in the Peer-to-Peer Software Application.

The present invention may be utilized for many purposes in addition to the skip-tracing function of locating a particular debtor. A Peer may utilize the Peer-to-Peer Software Application as described for electronic discovery, identity verification, information verification, credit scoring and the like. For example, Peer A 102 may be a small business lender seeking current account information on a particular consumer who is not listed with the major Consumer Reporting Agencies. Peer A 102 may use the Peer-to-Peer network to query other Peers and obtain current account payment and status data on the consumer to determine whether or not to conduct business with that consumer. In particular, if Peer A 102 obtains account payment data of current recent payments and no evidence of overdue accounts, Peer A may then decide to extend credit to a consumer who would have been otherwise rejected based on their lack of credit history with the major Consumer Reporting Agencies.

FIG. 2A is a workflow diagram 250 showing the details of the Authentication, Encryption, and Trust processes for the exemplary embodiment shown in FIG. 2. Peer A, with the Peer-to-Peer Software Application installed, connects 252 to the Communications Network. Peer A transmits 254 a request for a Communications Session to another Peer B 254. The request for a Communications Sessions is digitally signed with Peer A's private key 254 and includes a copy of Peer A's public key. Peer B receives 256 the request for a Communications Session from Peer A, verifies the message by decrypting the digital signature with Peer A's public key and responds with an Authentication message which is digitally signed with Peer B's private key and encrypted with a session key generated by Peer B. A copy of the session key is attached to the Authentication message and encrypted with Peer A's public key to ensure that only Peer A may decrypt the session key and thus decrypt the message.

Peer A receives Peer B's message which is encrypted with the session key generated by Peer B. Peer B's message also includes a copy of the session key generated by Peer B which is encrypted with Peer A's public key. Peer A decrypts the session key using Peer's A private key. Once Peer A has decrypted the session key, Peer A then decrypts Peer B's message. Peer A verifies Peer B's message by decrypting the digital signature of Peer B included with the message with Peer B's public key. Peer A requests 260 Trust Metrics on Peer B from a Trusted Peer C, and requests Peer-to-Peer Software version information from Peer B. Peer A receives 262 the Trust Metrics on Peer B from Peer C and assigns a Trusted status to Peer B if the Trust Metrics are above a predetermined minimum and if Peer B is running the latest version of the Peer-to-Peer Software. Therefore, Peer B is an Authenticated and Trusted Peer of Peer A. All of these transactions are a ‘two-way street,’ meaning that Peer B is taking the same steps to ensure the Authentication and Trust status of Peer A. In alternative embodiments, the session key may be attached to every message, or the encryption process may rely solely upon public key encryption, upon another method of maintaining secrecy, or upon a combination of methods.

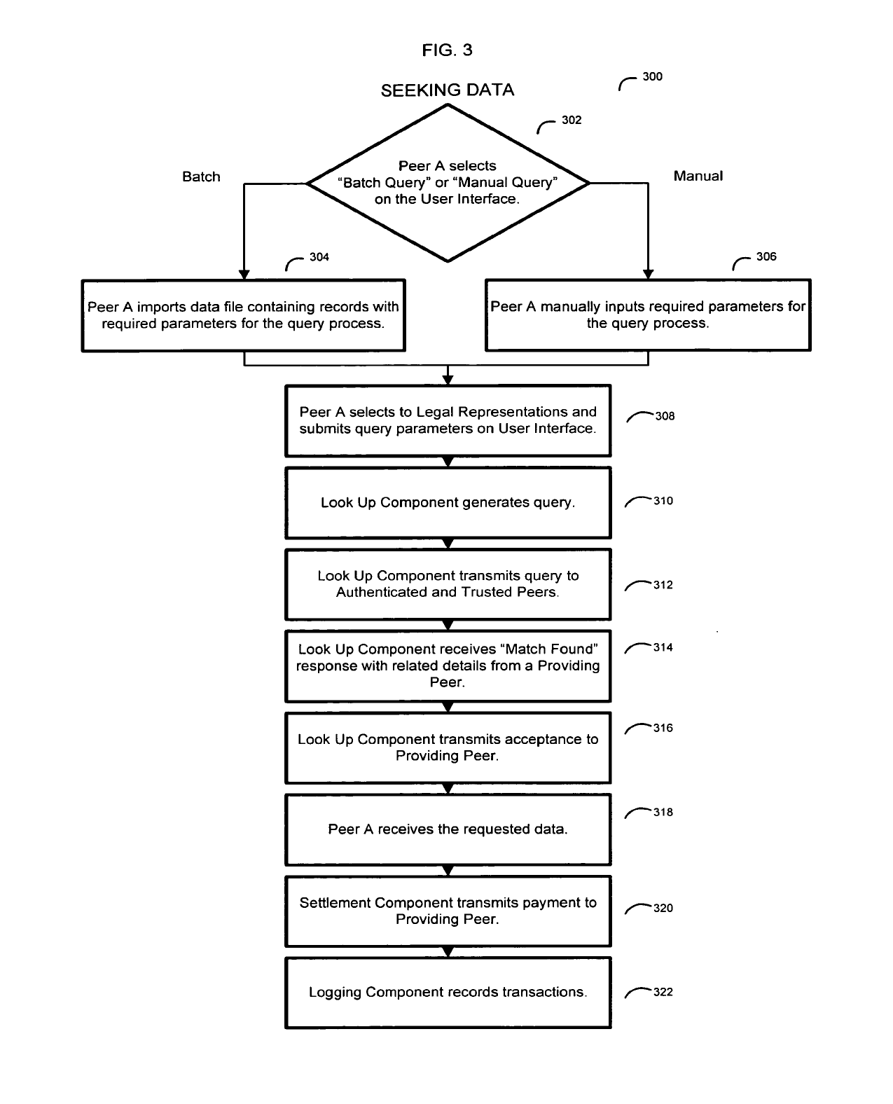

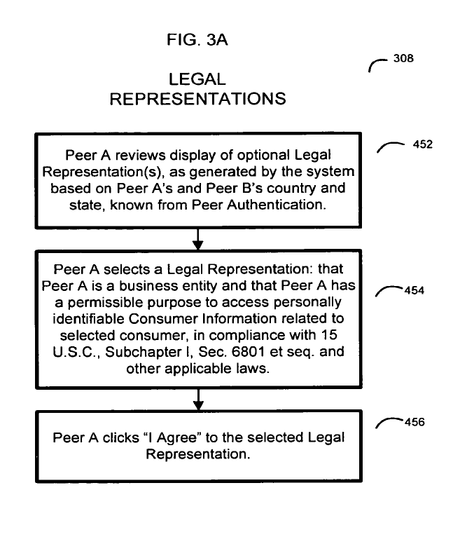

FIG. 3 is a workflow diagram 300 depicting one exemplary embodiment for the process of a Peer Seeking Data in a Peer-to-Peer network. The Seeking Data workflow 300 of FIG. 3 presumes that a Peer A has already Authenticated and established Trust with at least one other Peer. To initiate a query for data in this exemplary embodiment, Peer A first selects 302 either a “Manual Query” or “Batch Query” on the User Interface. For example, Peer A may be a collections agency trying to collect on an account where Peer A holds in its database a verified Name and Social Security Number (SSN) for a particular account, but only has an Address that has been proven to be incorrect. Peer A is therefore seeking a current, and preferably verified, Address for this account.

For a “Manual Query,” Peer A manually inputs 306, on the browser interface of the Peer-to-Peer Software Application, the required parameters for the query process. For example, Peer A may input a query for the current Address for the known consumer, specifying the known parameters Name and SSN. Peer A may specify a verified Address or an Address that has been updated within the past three or six months.

For a “Batch Query,” Peer A may import 304, again using the browser interface, a plurality of data records for the query process. For example, Peer A may import the data records for several (or several thousand) accounts to create a query for missing data from all such files. Peer A may need a current Address for a thousand such files. The “Batch Query” process allows the Peer to seek multiple data records without having to manually input each query parameter.

Peer A must then select 308 the appropriate Legal Representations in order to submit the query parameters. In this exemplary embodiment, the Legal Representations include an agreement that Peer A will comply with the applicable laws for the transfer of such information. For example, Peer A may represent that he has a permissible purpose to obtain personally identifiable consumer information pursuant to any applicable laws or regulations, such as a particular section of the Gramm-Leach-Bliley Act, 15 USC Subchapter I, §6801, et seq. The plurality of appropriate Legal Representations from which Peer A may select are stored within the Peer-to-Peer Software Application. The internal database of appropriate Legal Representations is periodically updated through the Update Component.

The Look Up Component of the Peer-to-Peer Software Application generates 310 the query and transmits 312 the query to connected Peers. After the other Peer systems apply the query to their Indices, one or more Peers may find matching records in their databases. The Look Up Component of Peer A may then receive 314 a “Match Found” response from a Providing Peer with matching data. The response 314 lists the type of matching data, the format of the matching data and the cost of the data. In alternative embodiments, the “Match Found” response may also list the date of the Address update and/or whether the Address has been verified. A Providing Peer may increase the cost of the data for a recent update or verified data.

The Look Up Component may then transmit 316 an acceptance to the Providing Peer, stating that Peer A will pay the requested fee for the data. In alternative embodiments, a Peer's system may be set to automatically accept a certain level of fee, or other such automated decisions.

Peer A receives 318 the data from the Providing Peer. After Peer A receives 318 the data, the Settlement Component transmits 320 the payment to the Providing Peer, and, in some embodiments, a royalty payment to the Software Distributor. Lastly in the workflow 300, the Logging Component records 322 the transaction.

In alternative embodiments, the process of maintaining persistent queries may be included in the Peer-to-Peer Software Application of the present invention. For example, if it is known in the system that no match has ever been found for a certain query, the Peer-to-Peer Software Application of each Peer may cache the query and the Scheduler Component may run the query and forward the query at a set periodic rate, or as a triggered event such as the addition of a new known Peer. The query may then be forwarded to a new Peer who may have data matching the query. Another alternative embodiment may provide an algorithm or other such method for the system to calculate the most efficient number of queries to be transmitted for the network. For example, in a very large network, a wide distribution of a query may overload the communication system of the requesting Peer.

Additionally, in alternative embodiments, if more than one Peer responds with matching data, the Peer-to-Peer Software Application of the requesting Peer may choose the “best” Peer from which to receive data. For example, the providing Peer with the highest bandwidth connection, smallest queue, lowest cost or clearest signal may be chosen.

FIG. 3A is a detailed workflow of an exemplary process for implementing Legal Representations. Peer A reviews 452 the display of optional Legal Representations, as generated by the Peer-to-Peer Software Application of the present invention based on the type of query and Peer A's and Peer B's country and state, which may be obtained from meta data embedded within Peer B's public key.

In this example, Peer A selects 454 the Legal Representation that states that Peer A is a business entity with a legally permissible purpose to access personally identifiable Consumer Information related to the selected consumers, in compliance with 15 U.S.C., Subchapter I, Sec. 6801 et seq. and other applicable laws. Peer A clicks 456 “I Agree” to the selected Legal Representation to create a binding “click-wrap” contract.

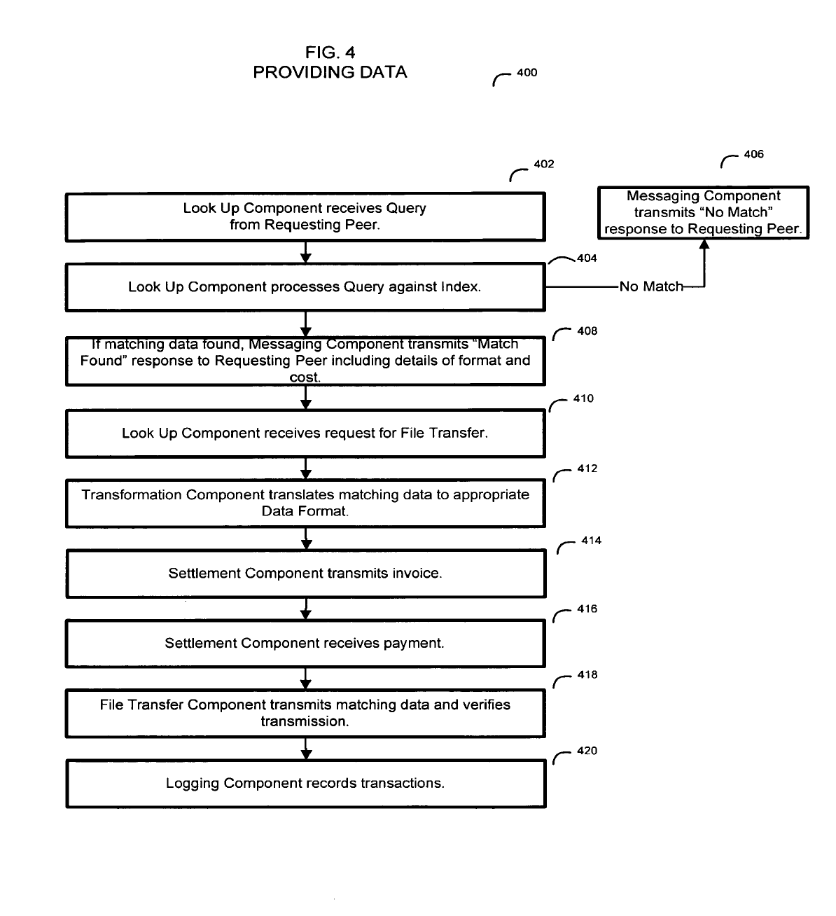

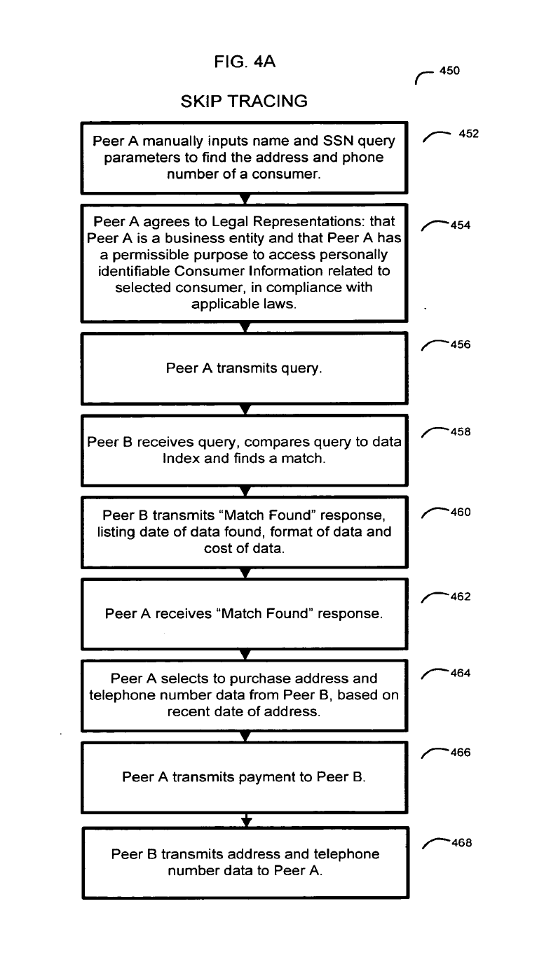

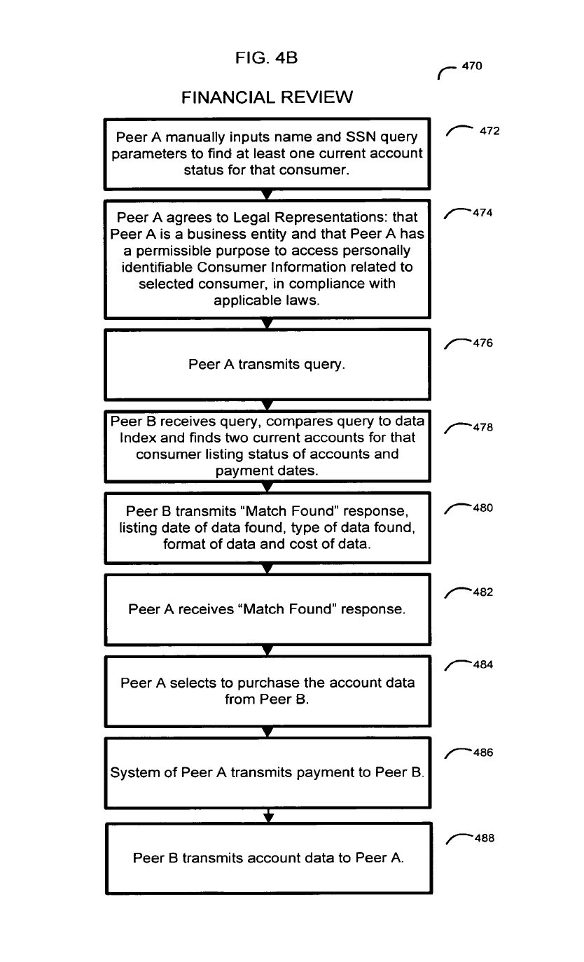

FIG. 4 is a workflow diagram 400 depicting an exemplary embodiment for the process of a Peer Providing Consumer Information to another Peer in a Peer-to-Peer network. The Providing Data workflow 400 presumes that a Providing Peer has already established a secure connection with at least one other Peer. The workflow diagram 400 also presumes that the system of the Providing Peer has created an Index of the Peers underlying database of Consumer Information.

When the Look Up Component of the Providing Peer receives 402 a query from a Requesting Peer, the Look Up Component processes 404 the query against the Index. For example, as in FIG. 3, the Requesting Peer may be seeking a current Address for a known debtor. If a match is not found, the Messaging Component transmits 406 a “No Match” response to the Requesting Peer. In alternative embodiments, the system may only respond if a match is found.

If a match is found, the Messaging Component of the Providing Peer's system transmits 408 a “Match Found” response to the Requesting Peer. The “Match Found” response may include certain details such as the type of data, the age of the data, the format of the data and the cost of the data.

If the Look Up Component receives 410 a request for a file transfer, the Transformation Component will be triggered to translate 412 the matching data to the appropriate Data Format. In this exemplary embodiment, the Data Format defined by each Peer is an XML DTD. It may be a Standard Data Format supplied with the Peer-to-Peer Software Application or any other XML format defined by the Peer, as long as the appropriate DTD is provided. In alternative embodiments, the Data Format may be any other, formats, e.g., delimited text files, fixed length test files, and the like.

The Settlement Component of the Providing Peer transmits 414 an invoice. If the payment is received 416 by the Settlement Component, then the File Transfer Component transmits 418 the matching data record(s) in the defined Data Format along with the required XML DTD, and verifies 418 the transmission and receipt. The Logging Component records 420 the transactions.

FIG. 4A depicts a workflow diagram for utilizing a Peer-to-Peer Exchange for skip tracing, that is to locate a particular debtor, in accordance with an exemplary embodiment of the present invention. The workflow diagram of FIG. 4A presumes that a Peer A and a Peer B are both connected to a Communications Network and that Peer A has established a secure connection with the authenticated and trusted Peer B. In the scenario of the workflow diagram 450, Peer A is a small collections agency trying to collect on past-due accounts. For one account in particular, the collections agency has a name and verified SSN for a debtor, but does not have a current address or telephone number. In the first depicted step, Peer A manually inputs 452 the name and SSN, as query parameters, in to the Peer-to-Peer Software Application user interface. Peer A also inputs 452 the requested, or sought, parameters of address and telephone number.

Next, Peer A must agree 454 to certain Legal Representations for each submitted query. There are many laws and regulations enacted to protect consumers and maintain consumer privacy. However, there are legal, permissible uses of Consumer Information and legal ways to exchange Consumer Information with other entities. Therefore, in this embodiment of the present invention, the Peer-to-Peer Software Application contains standardized Legal Representations to which Peer A may agree. The Peer-to-Peer Software Application presents a list of Legal Representations to Peer A and Peer A chooses the applicable representations and selects “I Agree,” to legally accept the commitment to the listed permissible uses of Consumer Information. For example, one Legal Representation might be “To effect, administer, or enforce a transaction requested or authorized by the consumer.”

Peer A transmits 456 the query to all connected, authenticated and trusted Peers. The system of Peer B receives 458 the query and compares the query to the Index of Peer B. The system of Peer B finds 458 a match, being an address and telephone number related to the name and SSN sent by Peer A. In this example, Peer B is a utility company that has an account with the debtor, and therefore has a recent and verified address and telephone number.

Peer B transmits 460 the “Match Found” response to Peer A, listing the last update date for the matching data, the format of the data and the cost of obtaining the data. Peer A receives a 462 “Match Found” response from Peer B. Peer A, based on the recent date of the data and an acceptable cost, selects 464 to purchase the address and telephone number data from Peer B. Peer A transmits 466 the required payment to Peer B. Upon receipt of payment, Peer B transmits 468 the address and telephone number data to Peer A. As discussed previously, in alternative embodiments, the payment could be transmitted after receipt of the data, or a third party entity could be used to escrow both the data and payments.

FIG. 4B is a process diagram depicting an exemplary workflow for utilizing a Peer-to-Peer Exchange for a Financial Review authorized by a particular consumer, that is to discover current account information on a particular debtor or debtors, in accordance with an exemplary embodiment of the present invention. Peer A manually inputs 472 a name and corresponding SSN as query parameters in the User Interface of the Peer-to-Peer Software Application, and select to seek a current account status for that consumer. Peer A agrees 474 to the Legal Representations associated with that query. In this example, the Legal Representations may state that Peer A is a business entity with a legally permissible purpose to access personally identifiable Consumer Information, in accordance with the applicable laws, in that the consumer has given authorization to access such information. The process of the Legal Representations was presented in more detail with reference to FIG. 3A.

Peer A transmits 476 the query to known Authenticated, Encrypted and Trust Peers, with reference to the process of FIG. 2A.

Still referring to FIG. 4B, Peer B receives 478 the query from Peer A, compares the query to Peer B's data Index, and finds two current accounts for that consumer, with account status data and payment date data. Peer B transmits 480 a “Match Found” response to Peer A, listing the date, type, format and cost of the matching data.

Peer A receives 482 the “Match Found” response and selects 484 to purchase the account data from Peer B. Peer A transmits 486 the payment to Peer B and Peer B transmits 488 the account data to Peer A. Peer A may then review the current account data of the consumer. In this example, Peer A may determine that the consumer, who was not listed with a credit reporting agency, is paying their debts in a timely manner and may be considered for a line of credit.

FIG. 5 depicts the representative Components of a Peer-to-Peer Software Application constructed in accordance with an exemplary embodiment of the present invention. The Components are displayed in a simplistic stack formation, in no particular order or ranking. Each Component is a computing process that interacts with the other Components. The Kernel Component 502 manages and connects the other Components.

The Scheduler Component 504 is a computing process that triggers other Components on either a periodic or event-based schedule. For example, the Scheduler Component may trigger a connection with the Software Distributor to see if a newer version of the software is available for download, or trigger the Index Component to create an Index of the Consumer Information database. In addition, the Scheduler may queue and schedule incoming queries or be used to schedule any other computing process of the Peer to Peer Software Application.

The Connection Component 506 manages connections with Communications Networks, users of Communications Networks and instances of the Peer-to-Peer Software Application operating on a Communications Network. The Connection Component 506 relies on inputs from the Security Component 508, the computing process that provides the framework for authorizing the transmission of data in a particular Communications Session, and the Encryption Component 516. For example, the Connection Component 506 will rely on determinations of Authentication and Trust, as determined by the Security Component 508 and the Encryption Component 516 to encrypt communications sessions with other Peers.

The Indexing Component 510 creates an Index of the Peer's database of Consumer Information. The Index is created to prevent exposure of underlying data and to improve the speed of queries. The Index is utilized by the Look Up Component 512, a computing process that generates, transmits, processes and forwards queries to other instances of the Peer-to-Peer Software Application operating in a Communications Network. The Index is also utilized by the Transformation Component 514.

The Transformation Component 514 creates a data map and converts raw data from the Consumer Information database to a Standard Data Format defined by the Peer-to-Peer Software Application. In this exemplary embodiment, all data transmitted to other Peers is transformed, by the Transformation Component 514, into an XML DTD that has been selected as the standard for the Peer-to-Peer network or chosen by a particular Peer. Such transformation allows Peers to maintain their underlying data in any format and still exchange data easily with any other Peer.

The File Transfer Component 518 transmits and receives all sets of data records exchanged between Peers. All transmissions are produced by the Transformation Component 514 and encrypted for security and privacy by the Encryption Component 516.

The Messaging Component 520 creates and distributes messages. For example, if the Look Up Component 512 receives a query from another Peer and finds matching data, the Messaging Component 520 will transmit a message to the requesting Peer stating the data found, the format of the data and the cost of the data. In alternative embodiments, the Messaging Component 520 could communicate directly with the Peer's system by email.

The Settlement Component 522 manages the accounting for successful Transactions based on the Record Type transmitted and the price associated with that Record Type. The Settlement Component 522 ensures that an invoice is sent and a payment received for each successful Transaction of data between Peers. In this exemplary embodiment, the Settlement Component 522 also ensures that a royalty payment is transmitted from the requesting Peer to the Software Distributor.

The Logging Component 524 records the activity of other Components. The Reporting Component 526 may then create organized, human readable presentations of the Transactions, Settlements or other activities recorded by the Logging Component 524.

In alternative embodiments, a separate Mapping Component may be included to produce the XML DTDs defined by a particular Peer or a particular system. Also, in alternative embodiments, an Updating Component may be utilized to distribute modifications, or revised versions, of the Peer-to-Peer Software Application to other Peers. The updates may be distributed by all Peers, one designated Peer or by a Software Distributor entity. The status of updates may be used as a Trust parameter. For example, in order to attain Trusted status, a Peer may be required to have the latest version of the Peer-to-Peer Software Application. The Update Component may also assist in protecting the code from hackers or other abuse, as the code may be periodically updated and edited to take advantage of the latest technologies and strategies.

FIG. 6 presents a detailed functional diagram of the exemplary Components for the Peer-to-Peer Software Application shown in FIG. 5, showing basic functions of each component. The Kernel Component 601 performs the functions of: Open Inter-Component Connection 602, Close Inter-Component Connection 603, Manage Inter-Component Connection 604, Open Thread, 605, Close Thread 606, Manage Thread 607 and manage the Quality of Service (QoS) 608. Managing the QoS may include the distribution of the available bandwidth or system resources, the number of allowable connections and the like. Therefore, the Kernel Component 601 oversees the operations of entire Peer-to-Peer Software Application system and the other Components. In particular, the Kernel Component 601 controls the threads of the Application, including but not limited to input/output and memory management. The Kernel 601 manages the threads to ensure Quality of Service 608 for the entire system. For example, if too many queries come in at the same time, the Kernel Component 601 will send the overflow to the Scheduler 610 and prompt the Messaging Component to send appropriate notifications to the affected Peers.

The Scheduler Component 610 performs the functions of: Schedule Event 611, Trigger Event 612 and Store Event 613. The Messaging Component 615 performs the functions of: Generate 616, Transmit 617 and Receive 618. As discussed with reference to FIG. 2, the Messaging Component 615 may perform these functions on messages transmitted either to a Peer or to a Peer's system. In addition, the Scheduler Component 610 controls job queuing for the entire Peer-to-Peer System and coordinates the actions of the other Components. In alternative embodiments, the functions of a Kernel 601 and Scheduler 610 Components may be provided by a plurality of job-queuing and management Components, or simply by adding such queuing and management functions to the other Components of the System.

The Security Component 620 performs the functions of: Authenticate Peers 621, Query Network for Trust Metric Ratings 622, Cache Trust Metric Ratings 623, Transmit Trust Metric Ratings 624, Sign Keys 625 and Generate Session Keys 625. Therefore, the Security Component 620 maintains the integrity of the system by ensuring that all Peers are fully Authenticated, validated as to their claimed identity, and have an allowable Trust Rating. The Trust Metrics may be gathered by the Security Component 620 by Querying 622 the other Peers; or, in alternative embodiments, the Security Component 620 may query a centralized Trust authority or certification company.

In other words, the Security Component 620 may also create 622 and respond 624 to queries to determine whether a Peer has a sufficient Rating for a particular Trust Metric relative to another Peer. While a Peer may be Authenticated by another Peer, the transmission of additional data is dependent on a sufficient Trust Metric Rating. In this exemplary embodiment, when one Peer attempts to determine the Trust Metric Rating of another Peer, the Security Component queries 622 a dynamic and decentralized set of Trust data known to the Peer-to-Peer System. For example, the Security Component 620 may broadcast a Trust query 622 to all known Peers on the shared Communications Network, consolidate the responses and calculate a singular value, or Rating, for each defined Trust Metric. The calculated Ratings are compared to the acceptable values for the particular Trust Metric defined for the particular Peer. If the Trust Metric Rating is at or above the pre-determined acceptable Trust Metric Rating, the Communications Session is continued. In alternative embodiments the Security Component 620 may query a centralized set of Peer Trust data, a third party entity that provides Trust data or the like.

The Connection Component 630 performs the functions of: Open External Connection 631, Close External Connection 632, Manage External Connection 633, Cache External Connection 634 and Manage Connection QoS 635. Therefore, the Connection Component 630 maintains all lines of communication between the Peer's system and other Peers. The QoS function 635 may ensure optimal bandwidth usage, optimal number of allowable connections and the like.

The Look Up Component 640 performs the functions of: Generate Query 641, Execute Query 642, Cache Query 643, Publish Query Results 644, Transmit Query 645, Receive Query 646 and Validate Query 647. As will be discussed more completely with reference to FIG. 4, the Look Up Component 640 seeks and provides data between the Peers.

The Transformation Component 650 performs the functions of: Retrieve Data Flagged for Transmission 651, Retrieve Standard Format 652, Translate File into Standard Format 653 and Create Data Map 654. In this exemplary embodiment, the Standard Format is an XML DTD that is defined either by a particular Peer or by the system. However, in alternative embodiments, any data standard may be utilized as long as the data format is defined and translatable.

The File Transfer Component 655 performs the functions of: Receive File 656, Transmit File 657, Acknowledge Receipt of File 658 and Verify File 659. In alternative embodiments, a method for file compression may be utilized for the transmission of large data sets.

The Index Component 660 performs the functions of: Create Index 661, Update Index 662 and Publish Index 663. The Logging Component 665 performs the functions of: Monitor Components 666, Record Events 667 and Publish Log 668. The Reporting Component 670 performs the functions of Define Reports 671, Query 672 and Publish Report 673. The Settlement Component 675 performs the functions of: Monitor for Transactions 676, Transmit Invoice 677, Transmit Payment 678 and Receive Payment 679. The Encryption Component 680 performs the functions of: Encrypt 681 and Decrypt 682.

The exemplary embodiments discussed thus far provide a Peer-to-Peer Software Application, system and method for exchanging Consumer Information within a decentralized architecture. The Software Distributor entity may collect royalty fees and may maintain the code base, but it does not act as a centralized authority or centralized database. In alternative embodiments, the Peer-to-Peer network of the present invention may comprise different architectures, including but not limited to a decentralized with no Software Distributor entity, centralized data management, centralized Index management, centralized Settlement of payments, partial centralization, any combination of such architectures and the like.

Those skilled in the art will also appreciate that the Peer-to-Peer exchange of Consumer Information described represents only one example of the various network types and configurations that will be suitable for implementation of the various embodiments of the invention. Accordingly, the scope of the present invention is described by the claims appended hereto and supported by the foregoing.

What is claimed is:

1. A system for obtaining consumer information, comprising:
a peer-to-peer communication network comprising a plurality of first peer computing nodes connected to the peer-to-peer communication network; and
a second computing node that is configured to:
connect to the peer-to-peer communication network;
identify a plurality of authenticated and trusted first peer computing nodes from the plurality of first peer computing nodes by completing an authentication of each of the plurality of first peer computing nodes and responsively, completing a trust evaluation for each of the authenticated first peer computing nodes, the trust evaluation determines that the authenticated first peer computing node is a trusted peer computing node only if the authenticated first peer computing node has at least a minimum trust metric rating,
wherein to complete the authentication of each of the plurality of first peer computing nodes, the second computing node is configured to:
generate and transmit a request for a communication session to each of the plurality of first peer computing nodes, wherein the request is digitally signed by the second computing node using a private key of the second computing node, and wherein the request includes a public key of the second computing node;
receive an authentication message from each of the plurality of first peer computing nodes, wherein each authentication message is: (a) digitally signed by a respective first peer computing node using a private key of the first peer computing node, and (b) encrypted using a session key generated by the respective first peer computing node, wherein each authentication message includes an encrypted copy of the session key that is encrypted by the respective first peer computing node using the public key of the second computing node, and
decrypt the session key of each of the plurality of first peer computing nodes using the private key of the second computing node and responsively, decrypt each authentication message using the decrypted session key of the respective first peer computing node, and
verify the authentication message of each of the plurality of first peer computing nodes by decrypting the digital signature of the respective first peer computing node using a public key of the respective first peer computing node;
prepare a query comprising a request for consumer information and a legal representation affirming a legally allowable purpose for obtaining the requested consumer information, the requested consumer information comprising information regarding a third party;
transmit the query to the plurality of authenticated and trusted first peer computing nodes;
receive a communication from ones of the plurality of authenticated and trusted first peer computing nodes in response to the query, each communication indicating that the ones of the plurality of authenticated and trusted first peer computing nodes possess at least a portion of the requested consumer information;
obtain the portion of the requested consumer information from a selected one of the plurality of authenticated and trusted first peer computing nodes based on a completeness of the portion of the requested consumer information received from the selected one of the plurality of the authenticated and trusted first peer computing nodes; and
transmit a payment to the selected one of the plurality of authenticated and trusted first peer computing nodes as compensation for delivery of the portion of the requested consumer information.

2. The system of claim 1, wherein the second computing node is further configured to maintain a record comprising an identity for each of the plurality of authenticated and trusted first peer computing nodes.

3. The system of claim 1, wherein the requested consumer information comprises one of identification information, demographic information, and financial information, each associated with the third party, the third party being an identifiable individual or entity.

4. The system of claim 1, wherein the second computing node is further configured to:
select the selected one of the plurality of authenticated and trusted first peer computing nodes based on an application of selection criteria including the completeness and a timeliness of the portion of the requested consumer information;
issue a request for the requested consumer information to the selected one of the plurality of authenticated and trusted first peer computing nodes via the peer-to-peer communication network; and
receive the requested consumer information from the selected one of the plurality of authenticated and trusted first peer computing nodes via the peer-to-peer communication network.

5. The system of claim 1, wherein the legal representation comprises a statement of fact as of a certain time made by a party requesting the consumer information to another as a term of a consumer information request transaction, wherein the other party can contractually rely on the statement by the requesting party.

6. The system of claim 1, wherein the second computing node is further configured to obtain a peer-to-peer software application from a software distributor via the peer-to-peer communication network.

7. The system of claim 6, wherein the second computing node is configured to transmit the payment by submitting an electronic form of payment to the software distributor and the selected one of the plurality of authenticated and trusted first peer computing nodes.

8. The system of claim 1, wherein the second computing node is configured to import a batch data file comprising a plurality of query records, each query record defining at least one parameter for the query.

9. The system of claim 1, wherein the second computing node is configured to send an electronic form of payment to the selected one of the plurality of authenticated and trusted first peer computing nodes in response to receipt of an invoice relating to a service of delivering the requested consumer information in a designated data format.

10. The system of claim 1, wherein the selected one of the plurality of authenticated and trusted first peer computing nodes outputs the communication in response to obtaining a match of the request for consumer information against an index defining consumer information-related records for a database.

11. The system of claim 1, wherein each communication comprises a count of each match, a record type of each match, a date of each match, a document type definition for the record type of each match, and a cost per record for each record type.

12. A system for obtaining financial account information about a third party, comprising:
a peer-to-peer communication network comprising a plurality of first peer computing nodes connected to the peer-to-peer communication network; and
a second computing node that is configured to:
connect to the peer-to-peer communication network;
identify a plurality of authenticated and trusted first peer computing nodes by completing an authentication of each of the plurality of first peer computing nodes and responsively, completing a trust evaluation for each of the authenticated first peer computing nodes, the trust evaluation determines that the authenticated first peer computing node is a trusted peer computer only if the authenticated first peer computing node has at least a minimum trust metric rating;
accept a legal representation affirming a legally allowable purpose for obtaining financial account information for a third party;
prepare a query comprising a request for the financial account information and the legal representation;
transmit the query to the plurality of the authenticated and trusted first peer computing nodes via the peer-to-peer communications network;
receive a communication via the peer-to-peer communications network from certain responding ones of the plurality of the authenticated and trusted first peer computing nodes in response to the query, each communication indicating that the responding authenticated and trusted first peer computing node possesses the financial account information;
select, from the responding ones of the authenticated and trusted first peer computing nodes, an authenticated and trusted first peer computing node that has a highest current network connection bandwidth and that satisfies a completeness criteria of the financial account information as a source for the financial account information; and
obtain the financial account information from the authenticated and trusted first peer computing node via the peer-to-peer communications network.

13. The system of claim 12, wherein the second computing node is further configured to arrange for a payment as compensation for delivery of the financial account information by the authenticated and trusted first peer computing node.

14. The system of claim 12, wherein the legal representation comprises a statement of fact as of a certain time made by a party requesting the financial account information to another as a term of a financial account information request transaction, wherein the other party can contractually rely on the statement by the requesting party.

15. The system of claim 12, wherein to prepare the query, the second computing node is further configured to:
obtain parameters required to define the query, the parameters including data supporting the request for the financial account information and the legal representation;
agree to terms of the legal representation defined by the query; and
identify a set of authenticated and trusted first peer computing nodes from the plurality of authenticated and trusted first peer computing nodes to receive the query.

16. The system of claim 12, wherein each communication is output by the responding authenticated and trusted first peer computing nodes in response to obtaining a match of the request for financial account information against an index defining the financial account information-related records for a database, each communication comprising a count of each match, a record type of each match, a date of each match, a document type definition for the record type of each match, and a cost per record for each record type.

17. A system for obtaining skip trace information, wherein the system comprises:
a first computing node that comprises:
a connection component that is configured to connect the first computing node to a peer-to-peer communication network comprising a plurality of second peer computing nodes that are connected to the peer-to-peer communication network;
a security component that is configured to identify a plurality of authenticated and trusted second peer computing nodes from the plurality of second peer computing nodes by completing an authentication of each of the plurality of second peer computing nodes and responsively, completing a trust evaluation for each of the authenticated second peer computing nodes, the trust evaluation determines that the authenticated second peer computing node is a trusted peer computing node only if the authenticated second peer computing node has at least a minimum trust metric rating,
wherein to complete the authentication of each of the plurality of second peer computing nodes, the security component of the first computing node is configured to:
generate and transmit a request for communication session to each of the plurality of second peer computing nodes, wherein the request is digitally signed by the first computing node using a private key of the first computing node, and wherein the request includes a public key of the first computing node;
receive an authentication message from each of the plurality of second peer computing nodes, wherein each authentication message is: (a) digitally signed by a respective second peer computing node using a private key of the second peer computing node, and (b) encrypted using a session key generated by the respective second peer computing node, wherein each authentication message includes an encrypted copy of the session key that is encrypted by the respective second peer computing node using the public key of the first computing node, and
decrypt the session key of each of the plurality of second peer computing nodes using the private key of the first computing node and responsively, decrypt each authentication message using the decrypted session key of the respective second peer computing node, and
verify the authentication message of each of the plurality of second peer computing nodes by decrypting the digital signature of the respective second peer computing node using a public key of the respective second peer computing node;
a message component that is configured to:
accept a legal representation affirming a legally allowable purpose for obtaining skip trace information comprising information for a third party individual;
prepare a query comprising a request for the skip trace information, identifying information for the third party individual, and the legal representation;
transmit the query to the plurality of second peer computing nodes via the peer-to-peer computer communications network;
receive a communication via the peer-to-peer computer communications network from certain responding ones of the plurality of the second peer computing nodes in response to the query, each communication indicating that the responding peer computing node possesses at least a portion of the requested skip trace information and presenting a payment demand for a purchase of the skip trace information;
select one of the responding authenticated and trusted second peer computers as a source for the requested skip trace information based on an application of selection criteria comprising a completeness of the skip trace information and the payment demand;
a file transfer component that is configured to obtain the requested skip trace information from the selected one of the responding second peer computing nodes in response to issuing a request to the selected responding second peer computing node; and
a settlement component that is configured to complete a payment for the purchase of the requested skip trace information from the selected responding second peer computing node.

18. The system of claim 17, wherein the information for the third party individual comprises an address and a phone number for the third party individual.

19. The system of claim 17, wherein to obtain the skip trace information, the first computing node is configured to:
issue a request for the skip trace information to the selected one of the responding second peer computing nodes via the peer-to-peer communication network; and
receive the skip trace information from the selected one of the responding second peer computing nodes via the peer-to-peer communication network.

20. The system of claim 17, wherein the first computing node is further configured to:
receive, by the message component, a request for information for another third party individual from one of the plurality of authenticated and trusted second peer computing nodes;
determine, by a look up component of the first computing node, a match of the request for information for another third party individual against an index defining the information-related records in a database of the first computing node,
responsive to a positive determination of a match, transform, by a transformation component of the first computing node, the requested information for the other third party individual from a first form stored in the database to a second form preferred by the requesting authenticated and trusted second peer computing node; and
transmit, by the file transfer component of the first computing node, the transformed requested information to the requesting authenticated and trusted second peer computing node based on settlement of a purchase payment.
